(19) United States
(12) Patent Application Publication
(10) Pub. No.: US 2026/0082124 A1
(43) Pub. Date: Mar. 19, 2026

(54) IMAGE PROCESSING METHOD, APPARATUS, DEVICE, STORAGE MEDIUM AND PRODUCT

(71) Applicant: Beijing Zitiao Network Technology Co., Ltd., Beijing (CN)

(72) Inventors: Jia Guo, Beijing (CN); Xujie Tao, Beijing (CN); Shuo Liu, Beijing (CN); Mengqian Liu, Beijing (CN)

(21) Appl. No.: 19/244,263

(22) Filed: Jun. 20, 2025

(30) Foreign Application Priority Data
Sep. 18, 2024 (CN) 202411304528.8

(51) Int. Cl. H04N 23/67; H04N 23/61

(52) U.S. Cl. CPC H04N 23/67; H04N 23/61

(57) ABSTRACT

The disclosed embodiments provide an image processing method, apparatus, device, storage medium and product, and relate to the field of image processing technology. The method comprises: obtaining a first preview image captured by a camera; obtaining indication information for the first preview image; inputting the indication information and the first preview image into a pre-trained multimodal recognition model for recognition to obtain a target object in the first preview image; controlling the camera to take the target object as the shooting focus of the camera and shoot the target image.

### CROSS-REFERENCE TO RELATED APPLICATION(S)

This application claims priority to Chinese Application No. 202411304528.8 filed Sep. 18, 2024, the disclosure of which is incorporated herein by reference in its entirety.

### FIELD

The embodiments of the present disclosure relate to the field of image processing technology, and in particular, to an image processing method, apparatus, device, storage medium and product.

### BACKGROUND

AI (Artificial Intelligence) technology in combination with smart devices has significantly improved the intelligence level of smart devices. Among them, the camera on the smart device can collect data from the real physical environment, thereby realizing the embodied intelligence of the smart device.

### SUMMARY

In a first aspect, an embodiment of the present disclosure provides an image processing method, comprising:
obtaining the first preview image captured by the camera;
obtaining indication information for a first preview image;
obtaining a target object in the first preview image by inputting the indication information and the first preview image into a pre-trained multimodal recognition model for recognition; and
shooting a target image by controlling the camera to take the target object as the focus of the camera.

In a second aspect, an embodiment of the present application provides an image processing apparatus, comprising:
a first acquisition unit, configured to obtain a first preview image captured by a camera;
a second obtaining unit, configured to obtain indication information for the first preview image;
a recognition unit, configured to obtain a target object in the first preview image by inputting the indication information and the first preview image into a pre-trained multimodal recognition model for recognition; and
a control unit, configured to shoot the target image by controlling the camera to take the target object as the shooting focus of the camera.

In a third aspect, an embodiment of the present application provides a wearable device, comprising the image processing apparatus and a camera of the second aspect.

In a fourth aspect, an embodiment of the present disclosure provides an electronic device, including: a processor and a memory;
wherein the memory stores computer-executable instructions;
the processor executes the computer-executable instructions stored in the memory, causing at least one processor execute the image processing method of the first aspect and various possible designs of the first aspect as described above.

In a fifth aspect, an embodiment of the present disclosure provides a computer-readable storage medium, in which computer execution instructions are stored, the computer execution instructions, when executed by a processor, implement the image processing method as described in the first aspect and various possible designs of the first aspect.

In a sixth aspect, an embodiment of the present disclosure provides a computer program product, including a computer program, which, when executed by a processor, implements the image processing method as described in the first aspect and various possible designs of the first aspect.

### BRIEF DESCRIPTION OF THE DRAWINGS

In order to more clearly illustrate the embodiments of the present disclosure or the technical solutions in the prior art, the drawings required for use in the embodiments or the description of the prior art will be briefly introduced below. Obviously, the drawings described below are some embodiments of the present disclosure. For ordinary technicians in this field, other drawings can be obtained based on these drawings without paying creative labor.

FIG. 1 is an example diagram of an application scenario of an image processing method provided by an embodiment of the present application;

FIG. 2 is a flow chart of an image processing method provided in an embodiment of the present application;

FIG. 3 is an example diagram of a first preview image provided by an embodiment of the present application;

FIG. 4 is the first example diagram of an annotated sample image provided by an embodiment of the present application;

FIG. 5 is the second example diagram of an annotated sample image provided by an embodiment of the present application;

FIG. 6 is the third example diagram of an annotated sample image provided by an embodiment of the present application;

FIG. 7 is the first example diagram of a target image provided by an embodiment of the present application;

FIG. 8 is the second example diagram of a target image provided by an embodiment of the present application;

FIG. 9 is the third example diagram of a target image provided by an embodiment of the present application;

FIG. 10 is a flowchart of another image processing method provided in an embodiment of the present application;

FIG. 11 is a schematic diagram of the structure of an image processing apparatus provided in an embodiment of the present application; and

FIG. 12 is a schematic diagram of the structure of an electronic device provided in an embodiment of the present disclosure.

### DETAILED DESCRIPTION OF EMBODIMENTS

At present, there are some scenarios in which the camera of the smart device cannot capture accurate and clear target images, which in turn affects the performance of the smart device.

Embodiments The embodiments of the present disclosure provide an image processing method, apparatus, device, computer-readable storage medium and product, which are used to solve the technical problem that a camera cannot capture an accurate and clear target image.

In order to make the purpose, technical solution and advantages of the embodiments of the present disclosure clearer, the technical solution in the embodiments of the present disclosure will be clearly and completely described below in conjunction with the drawings in the embodiments of the present disclosure. Obviously, the described embodiments are part of the embodiments of the present disclosure, not all of the embodiments. Based on the embodiments in the present disclosure, all other embodiments obtained by ordinary technicians in this field without creative work are within the scope of protection of the present disclosure.

It is understandable that before using the technical solutions disclosed in the embodiments of the present disclosure, the type, scope of use, usage scenarios, etc. of the personal information involved in the present disclosure should be informed to the target users in an appropriate manner in accordance with relevant laws and regulations, and the target users'authorization should be obtained.

It is understandable that the above notification and the process of obtaining authorization of the target user are merely illustrative and do not constitute a limitation on the implementation of the present disclosure. Other methods that meet the relevant laws and regulations may also be applied to the implementation of the present disclosure.

With the development of AI technology and the combination of AI technology and smart devices, AI has gradually been integrated into people's daily lives. From smart home devices to mobile application devices, AI technology has significantly improved the intelligence level of smart devices. Among them, the emergence of embodied intelligent devices is becoming more and more prominent. In order to enable AI to capture and collect data of the real physical environment with higher quality, cameras have become an indispensable element of embodied intelligent devices. Cameras are one of the important ways to provide embodied data collection. Among the many tasks of embodied smart devices, only by accurately capturing the target object can the LLM (Large Language Model) accurately predict and infer the target object. However, in some scenarios, the camera may not be able to focus accurately. For example, when an object blocks the target object that the camera intends to capture, the camera cannot focus automatically, resulting in the captured target object sometimes being out of focus, unrecognizable or blurred, which ultimately affects the reasoning and prediction of LLM.

In order to solve the technical problem, the present disclosure provides an image processing method, apparatus, device, computer-readable storage medium and product, which analyzes indication information through a multimodal recognition model, recognizes a target object in a first preview image, and captures a target image with the target object as the focus, so that the camera can recognize the target object through the indication of the indication information without relying on manual focus determination, thereby automatically determining the focus and capturing the target image indicated by the indication information.

The image processing method, apparatus, device, storage medium and product provided in this embodiment comprise: obtaining a first preview image captured by a camera; obtaining indication information for the first preview image; inputting the indication information and the first preview image into a pre-trained multimodal recognition model for recognition to obtain a target object in the first preview image; controlling the camera to shoot the target image with the target object as the shooting focus of the camera. The application is based on multimodal input (indication information and first preview image), and accurately obtains the target object indicated by the indication information in the first preview image through multimodal recognition model processing and analysis, and shoots the target image with the target object as the focus, thereby obtaining a clear and accurate target image of the target object.

It should be noted that the image processing method, apparatus, device, storage medium and product provided by the present disclosure can be applied to any electronic device equipped with a camera.

The image processing method provided in the embodiments of the present application will be described in detail below with reference to the accompanying drawings.

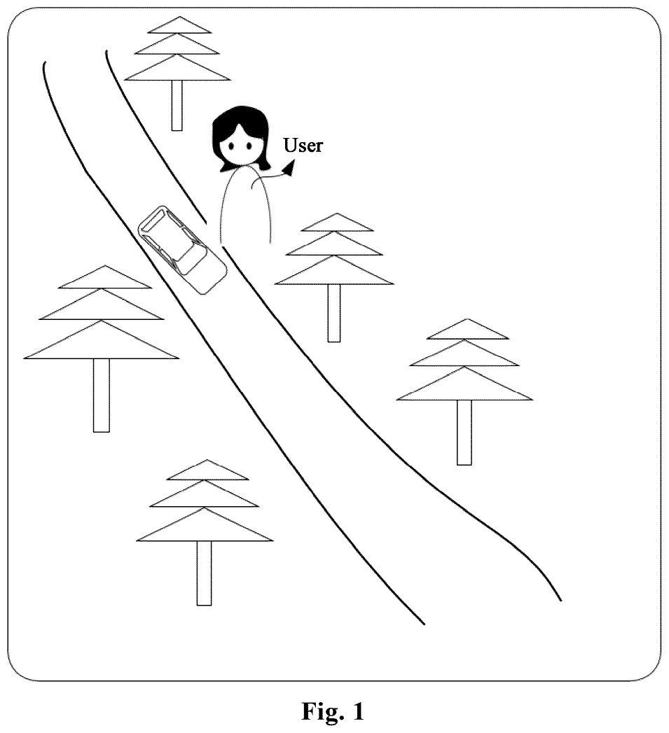

FIG. 1 is an example diagram of an application scenario of an image processing method provided by an embodiment of the present application. As shown in FIG. 1, a user wears a wearable device (not shown), the wearable device includes a camera, and the user can interact with the wearable device. The user is in a real physical environment, as shown in FIG. 1, when crossing the road, the user wants to confirm whether there is a vehicle on the road, then the user can input a voice “is there a vehicle on the road” to the wearable device, and then the wearable device can search for the vehicle in the preview image captured by the camera according to the voice, if the vehicle is found, a clear target image is taken with the vehicle as the focus, if the vehicle is not found, a clear target image can also be taken with the preset position (such as the center position) of the preview image as the focus, and then the wearable device recognizes the target image, and can accurately determine whether there is a vehicle on the road. It can be seen that if the target image taken by the camera is blurred, the wearable device cannot accurately recognize whether there is a vehicle in the target image, and therefore, the goal of the image processing method provided by the present application is to obtain a clear target image containing the target object.

FIG. 1 is only an exemplary application scenario. The present application is not limited to wearable devices, but can also be used in any other electronic devices equipped with a camera, such as mobile phones, cameras, tablets, etc.

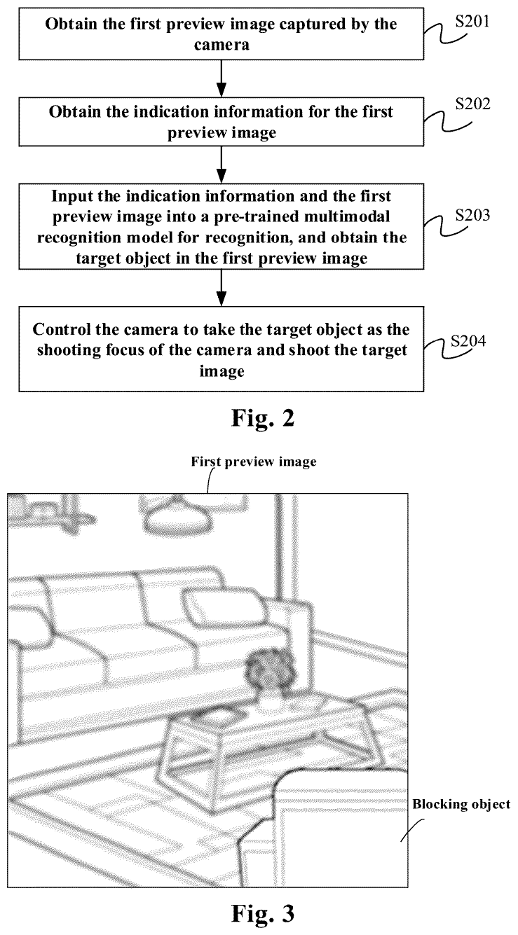

FIG. 2 is a flow chart of an image processing method provided in an embodiment of the present application. The image processing method may comprise the following steps.

S201, a first preview image captured by a camera is obtained.

In the embodiment of the present application, the first preview image is an image captured by the camera for the current scene, wherein the first preview image can be a blurred or clear image, which is not limited.

For example, referring to FIG. 3, which is the first preview image captured by the camera, in the first preview image, since the blocking object is closer to the camera, it blocks the object behind it. The camera will focus on the blocking object, causing other objects to be blurred in the first preview image and the blocking object to be clearer.

S202, indication information for the first preview image is obtained.

In an embodiment of the present application, the indication information includes natural language information in text format and/or natural language information in voice format. The indication information also includes at least one of: context information of the natural language information, the user's gaze point, the user's gaze direction, and the user's gesture. Among them, the user's gaze point, the user's gaze direction, and the user's gesture can be obtained based on image collection and recognition, or can be obtained by other means, which are not limited here.

In one embodiment, the natural language information includes: key information of the target object. For example, the natural language information is “what is the potted plant on the desk”, and the key information of the target object is “potted plant”.

In another embodiment, the natural language information does not include: key information of the target object, for example: the natural language information is “what is this” or “what is on the desktop”, etc., then the indication information also includes at least one of: contextual information of the natural language information, the user's gaze point, the user's gaze direction and the user's gesture.

For example, with respect to FIG. 3, the natural language information in text format is the text “what is the potted plant on the desktop” input by the user, the natural language information in voice format is the voice “what is the potted plant on the desktop” input by the user, or the natural language information in voice format input by the user is converted from natural language information in voice format into natural language information in text format through ASR (Automatic Speech Recognition).

In the embodiment of the present application, the content of the natural language information is any content input by the user, and the present application does not limit the content of the natural language information.

Furthermore, the indication information also includes at least one of: context information of the natural language information, the user's gaze point, the user's gaze direction, and the user's gesture.

S203, the indication information and the first preview image are input into a pre-trained multimodal recognition model for recognition, and a target object in the first preview image is obtained.

In an embodiment of the present application, the multimodal recognition model may adopt an MLLM (Multimodal Large Language Model) architecture, which is a multimodal processing model that can simultaneously process images (or videos) and natural languages. For example, the multimodal recognition model is a CLIP (a text-image cross-modal pre-training model based on contrastive learning) model based on the Transformer (a deep learning network based on a self-attention mechanism) architecture, or the multimodal recognition model is a model based on the DINO architecture (an end-to-end model architecture), or the multimodal recognition model is a model based on the SEEM (a segmentation model architecture) architecture. Among them, the architectures of multimodal models such as GLIP, DINO and SEEM have some common features in the training process, mainly focusing on the fusion of multimodal data, cross-modal alignment and large-scale data training.

Furthermore, the multimodal recognition model includes: a feature extraction layer and a cross-modal alignment layer.

Among them, the feature extraction layer includes an image encoder and a text encoder, such as a Transformer and a convolutional neural network. The feature extraction layer is used to extract the image features of the target image and the text features of the prompt information. The cross-modal alignment layer uses a cross-attention mechanism or a joint embedding space to fuse the image features and the text features to obtain fused features to improve the quality of the fused features in representing the target image and the prompt information, and then predicts and recognizes the fused features to obtain the predicted target object. Furthermore, in the cross-modal alignment layer, cross-modal learning is learned by aligning the image features and the text features, for example, using the regional features in the target image and the word features in the prompt information to establish a correspondence. In addition, the self-attention mechanism and the cross-attention mechanism are used in the cross-modal alignment layer to enhance the information between the modalities. Finally, the contrastive loss is used in the cross-modal alignment layer to ensure the alignment of features between different modalities, thereby improving the performance of the multimodal recognition model in multimodal tasks.

In the embodiments of the present application, the specific structure of the multimodal recognition model is not limited.

Among them, the multimodal recognition model is pre-trained. The specific training process is to first pre-train the multimodal recognition model on a large-scale and diverse training sample set to capture rich semantic information. Then the pre-trained multimodal recognition model can be fine-tuned in various downstream tasks to adapt to specific application scenarios, thereby improving generalization ability and task performance, and obtaining a trained multimodal recognition model.

Specifically, in the pre-training process of the multimodal recognition model, the present application first constructs a training sample set. The specific process of constructing the training sample set is: obtaining sample images collected by different wearable devices; annotating the sample images to determine that the annotated objects in the sample images are label data; and determining the sample prompt information of the annotated sample images.

Among them, wearable devices are such as headphones, rings, glasses or necklaces, etc. The annotation methods for sample images include: Text Prompt method, bounding box method or Segmentation method.

Furthermore, the specific pre-training process of the multimodal recognition model is: inputting sample images and sample prompt information into the multimodal recognition model, outputting predicted objects, and adjusting model parameters of the multimodal recognition model according to the predicted objects and label data.

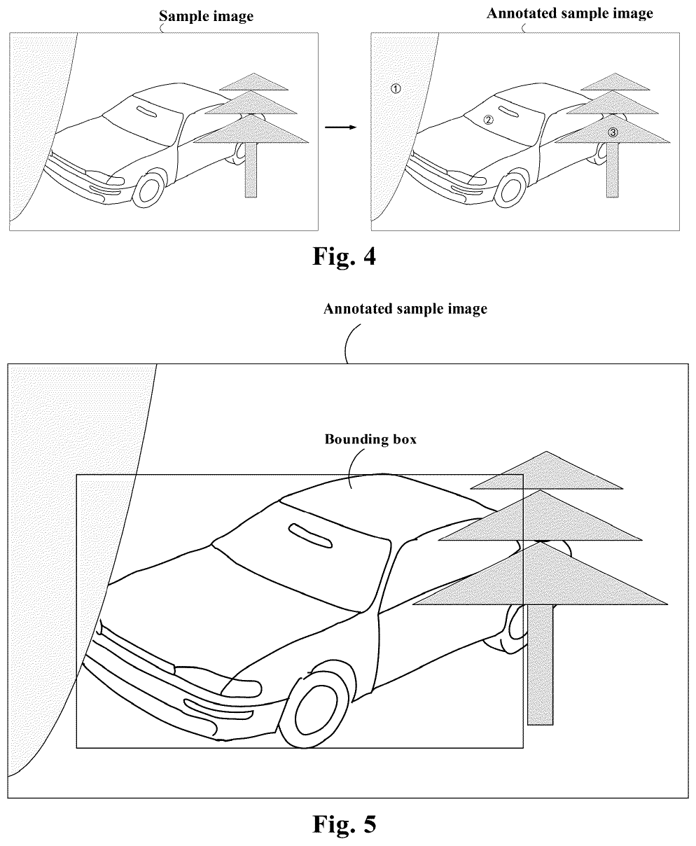

For example, referring to FIG. 4, the sample image is annotated by the Text Prompt method to obtain the annotated sample images, that is, symbols are annotated on different objects, such as \textcircled{1}, \textcircled{2}, and \textcircled{3}. In FIG. 4, the object represented by \textcircled{1} is the user's arm, the object represented by \textcircled{2} is a vehicle, and the object represented by \textcircled{3} is a tree. The corresponding sample prompt information is such as: \textcircled{1} what is it, or \textcircled{2}what is it, or \textcircled{3} what is it, or what is on the right of \textcircled{2}.

Referring to FIG. 5, the sample image is annotated by a bounding box to obtain the annotated sample images. In FIG. 5, the sample object (vehicle) is annotated by a bounding box. The sample prompt information may be: what type of vehicle is, or where the vehicle is.

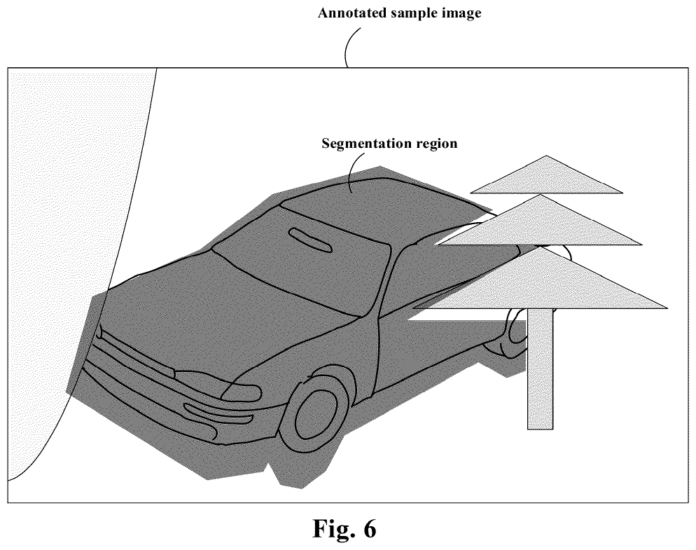

Referring to FIG. 6, the sample image is annotated by segmentation to obtain the annotated sample image. In FIG. 6, the sample object (vehicle) is segmented by segmentation regions. The sample prompt information may also be: what type of vehicle is, or where the vehicle is.

In one embodiment, if there is a gesture interaction action, that is, the collected sample image includes a gesture, then when annotating the sample object, the object pointed to by the gesture is annotated as the sample object, and the prompt information can be “what is this”, so that the multimodal recognition model learns the gesture interaction content.

In one embodiment, the training sample includes: a sample video, the sample video includes: a plurality of sample images in a time series. The sample video can be annotated to obtain an annotated sample object, and the sample video, sample prompt information and sample object are used to train a multimodal recognition model.

In another embodiment, an object with a specified feature in a sample image can be annotated as a sample image. The object with the specified feature is, for example, an object in the middle area of the sample image, or an object whose color or shape is more prominent than other objects. For example, other objects in the sample image are gray, white, or black, and the sample object is fluorescent blue, fluorescent yellow, or red. In the embodiment of the present application, the specified feature can be set according to actual needs and is not limited to this. The corresponding sample indication information can be: “what is this”, or “what is this yellow one”, or “what is this strange shape”.

In the embodiments of the present application, a training sample set for a multimodal recognition model may be constructed in a variety of ways, which are not limited herein.

In summary, this application trains the multimodal recognition model through training samples, allowing the multimodal recognition model to learn the relationship between the semantic description of the sample image and the corresponding sample prompt information, and can compare and learn the sample image with the natural language description to form a powerful cross-modal understanding ability. Let the multimodal recognition model automatically learn the association between the sample image and the sample prompt information from the training samples. After training the multimodal recognition model, it can well recognize the target object of interest to the user in the target image.

In one embodiment, the multimodal recognition model can parse the user's natural language information based on natural language processing to extract key information. For example, if the natural language information is “what is the potted plant on the desk”, the key information in the natural language information is “potted plant”, and then the multimodal recognition model recognizes the target object “potted plant”in the target image.

In another embodiment, if there is no key information in the natural language information, the multimodal recognition model can recognize the target object in the target image based on other indication information of the natural language information (at least one of the context information of the natural language information, the user's gaze point, the user's gaze direction, and the user's gesture). When recognizing the target object, it can be recognized based on the shape, color, or depth features of each object in the target image. If the target image includes a gesture object, the direction of the gesture object can also be recognized, thereby recognizing the target object in the target image.

S204, the target image is shot by controlling the camera to take the target object as the shooting focus of the camera.

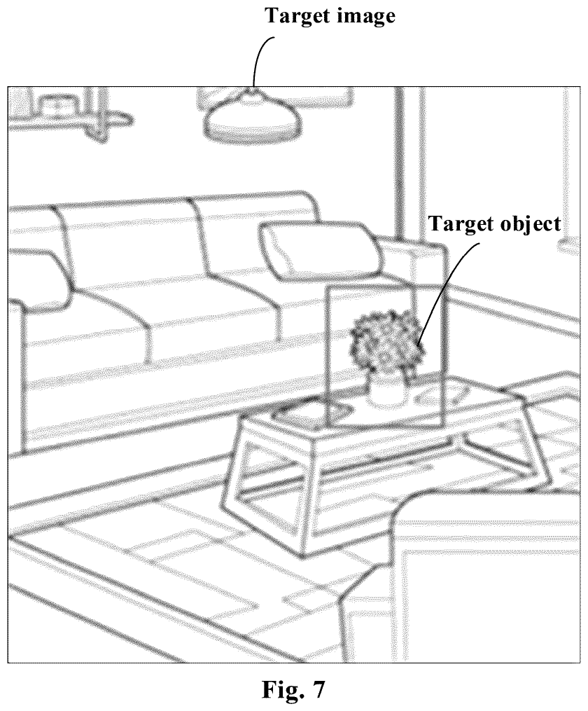

In one case, the target image is captured in a focusing manner, specifically, the camera is controlled to focus, the target object is used as the shooting focus of the camera, and the captured image is the target image. The target image obtained by using this method is shown in FIG. 7, in which the target object and the area around the target object are clear in the captured target image.

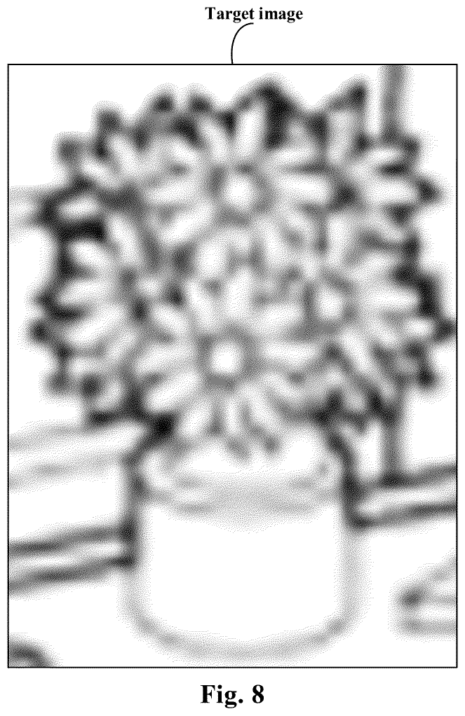

In another case, the target image is captured in a digital zoom manner, specifically, the camera is controlled to shoot the image, and then the target object in the captured image is cropped and enlarged to obtain the target image. In the digital zoom manner, the target object is also in focus. The target image obtained in this way is shown in FIG. 8. The target image includes the enlarged target object, and the target object may not be clear after enlargement. In the embodiment of the present application, the target image can be interpolated to improve the clarity of the target image.

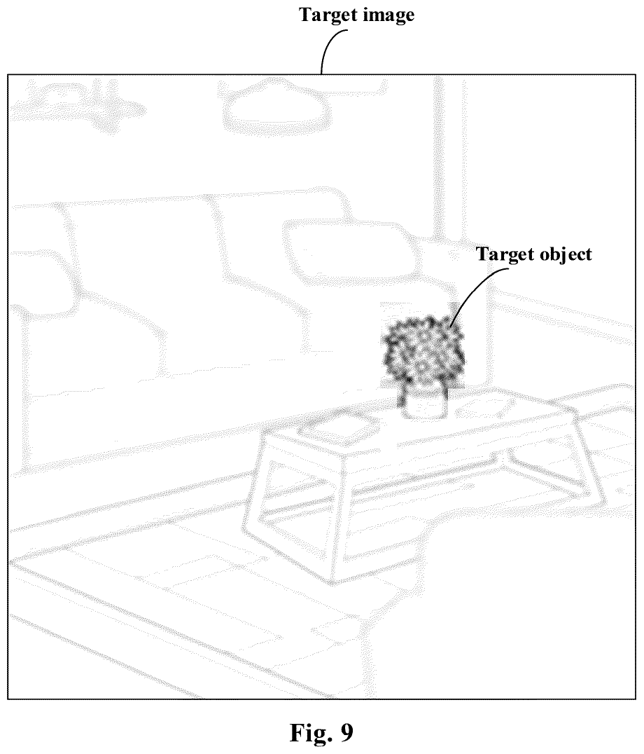

In another case, the target image is captured in a fixed-focus manner, specifically, the camera is controlled to focus, with the target object as the shooting focus of the camera. The target object in the captured target image is clearer, and the area outside the target object is blurred. The target image obtained by using this method is shown in FIG. 9. In FIG. 9, the target object is clearer, and the area outside the target object in the target image is blurred.

In summary, the present application analyzes the indication information through a multimodal recognition model, recognizes the target object in the first preview image, and shoots the target image with the target object as the focus. As a result, the camera can recognize the target object through the indication of the indication information without relying on manual focus determination, thereby automatically determining the focus and shooting and obtaining the target image indicated by the indication information.

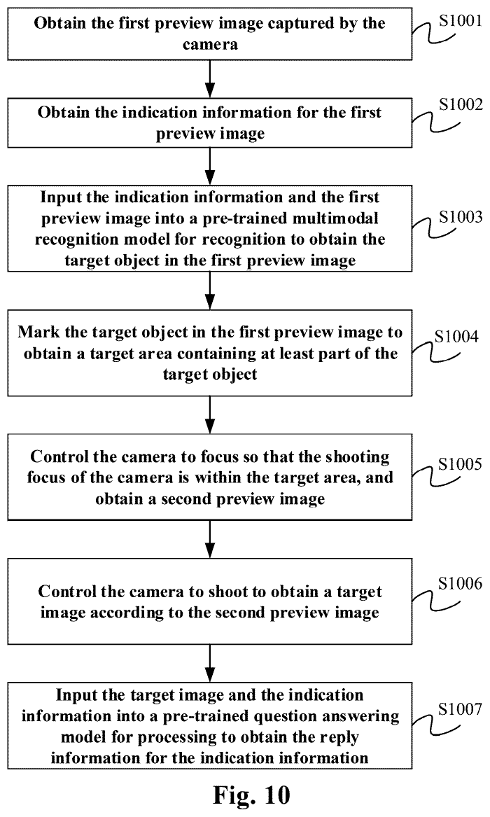

FIG. 10 is another flow chart of an image processing method provided in an embodiment of the present application. The image processing method comprises the following steps.

S1001, a first preview image captured by a camera is obtained.

S1002: indication information for a first preview image is obtained.

S1003: the indication information and the first preview image are input into a pre-trained multimodal recognition model for recognition to obtain a target object in the first preview image.

Among them, the specific implementation process of S1001 to S1003 refers to S201 to S203, which will not be repeated here.

S1004, a target object in the first preview image is marked to obtain a target area containing at least a portion of the target object.

In one embodiment, marking a target object in a first preview image to obtain a target area containing at least part of the target object comprises: in the first preview image, determining a rectangular area surrounding the target object as the target area. Among them, the target area includes: the target object. This marking method is suitable for the situations where the target objects that need to be quickly calibrated, and is suitable for target objects with relatively regular boundaries and no overlap with other objects. The calculation process of this marking method is simple, and it is suitable for real-time calibration of target objects, has high calculation efficiency and is suitable for wearable devices with limited computing resources.

In another embodiment, marking the target object in the first preview image to obtain a target area containing at least part of the target object comprises: determining a feature point on the target object in the first preview image; determining a circular area with the feature point as the center as the target area, and the radius of the circular area is a preset value. Among them, the target area includes: part of the target object or all of the target object. This marking method is suitable for applications that accurately locate specific parts or feature points, such as human posture estimation or facial feature expression.

In another embodiment, marking the target object in the first preview image to obtain a target area containing at least part of the target object comprises: determining the contour line of the target object in the first preview image; and determining the area surrounded by the contour line as the target area. Among them, the target area includes: the target object. This marking method has high calculation accuracy and is suitable for applications that require accurate description of the shape and boundaries of the target object, such as medical image analysis, fine object recognition, etc.

S1005, the camera is controlled to focus so that the shooting focus of the camera is in the target area, and obtaining a second preview image.

In the embodiment of the present application, the focus of the camera is adjusted to the target area, and then the image captured by the camera is the second preview image.

S1006, the target image is obtained by controlling the camera to shoot based on the second preview image.

In one embodiment, the second preview image is directly stored to obtain the target image.

In another embodiment, the contrast of the target area in the second preview image is determined, and the target image is captured based on the contrast. Specifically, controlling the camera to shoot to obtain the target image based on the second preview image, comprising: determining a first contrast of the target area in the second preview image; if the first contrast is greater than or equal to a preset threshold, controlling the camera to shoot to obtain the target image based on the second preview image.

In the embodiment of the present application, the preset threshold is pre-set. If the first contrast is greater than or equal to the preset threshold, it can be understood that the clarity of the target area meets the preset clarity requirement, and the second preview image can be directly saved as the target image.

In another embodiment, controlling the camera to shoot to obtain the target image based on the second preview image also comprises: if the first contrast is less than a preset threshold, controlling the camera to refocus so that the camera's shooting focus is in the target area to obtain a new second preview image; executing the step of determining the first contrast of the target area in the second preview image.

Among them, if the first contrast is less than the preset threshold, it can be understood that the clarity of the target area does not meet the preset clarity requirement, and the focus can be re-performed to obtain a new second preview image. The above steps are repeated until the contrast of the target area in the obtained second preview image is greater than or equal to the preset threshold, and the second preview image is saved as the target image.

The present application determines whether to capture a target image based on the size of the contrast, thereby ensuring the clarity of the target object in the target image.

S1007, the target image and the indication information are input into a pre-trained question-answering model for processing, and reply information of the indication information is obtained.

In the embodiment of the present application, the question-answering model is a multimodal network model that can output reply information for the target image and the prompt information. For example, the target image is shown in FIG. 7, the prompt information is “what is the potted plant on the desk”, and the reply information is “the potted plant on the desk is a bunch of sunflowers”.

Among them, since the target image taken in the present application is taken with the target object as the focus, the target object in the obtained target image is clear, and the clear target object can be more accurately recognized by the recognition model. For example, the recognition model can more accurately recognize the category, name and other attribute information of the target object, and thus can more accurately reply to the user's prompt information.

In summary, in the embodiments of the present application, the indication information is analyzed by a multimodal recognition model, the target object is recognized in the first preview image, and the target image is captured with the target object as the focus, so that the camera can recognize the target object through the indication of the indication information without relying on manual focus determination, thereby realizing automatic focus determination, and shooting to obtain the target image indicated by the indication information, which contains a clear target object. The target image and the prompt information are input into the question-answering model, so that the question-answering model can accurately recognize the target object, thereby improving the response accuracy of the question-answering model and improving the user experience.

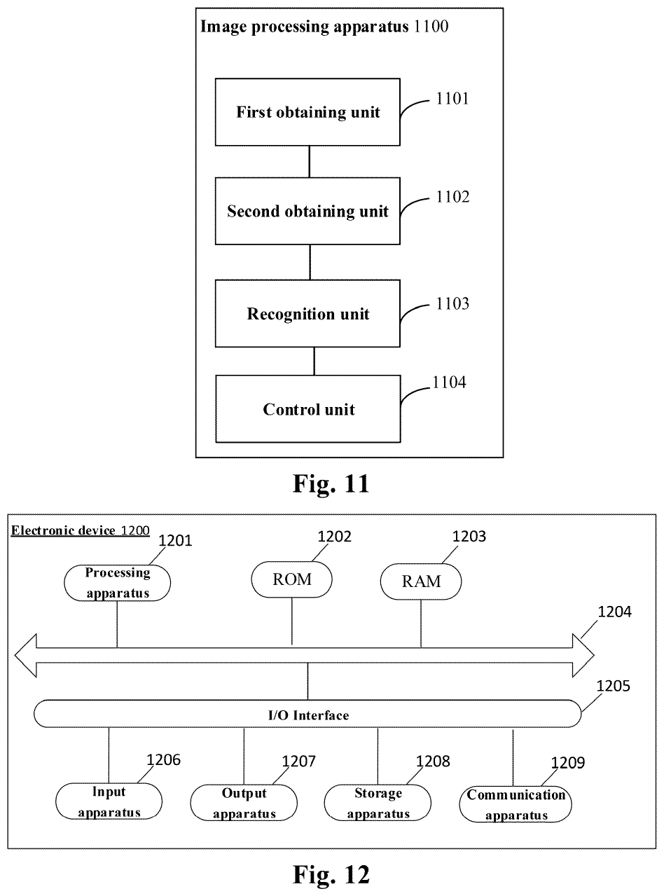

FIG. 11 is a schematic diagram of the structure of an image processing apparatus provided in an embodiment of the present application. The image processing apparatus 1100 may include the following units:

A first obtaining unit 1101, configured to obtain a first preview image captured by a camera;

A second obtaining unit 1102, configured to obtain indication information for the first preview image;

A recognition unit 1103, configured to input the indication information and the first preview image into a pre-trained multimodal recognition model for recognition, to obtain a target object in the first preview image; and
A control unit 1104, configured to control the camera to take the target object as the shooting focus of the camera to shoot the target image.

In some embodiments, the control unit 1104 is specifically used to: mark the target object in the first preview image to obtain a target area containing at least part of the target object; control the camera to focus so that the shooting focus of the camera is in the target area to obtain a second preview image; and control the camera to shoot to obtain the target image based on the second preview image.

In some embodiments, when the control unit 1104 marks the target object in the first preview image and obtains the target area containing at least part of the target object, it is specifically configured to: determine a rectangular area surrounding the target object in the first preview image as the target area.

In some embodiments, when the control unit 1104 marks the target object in the first preview image and obtains a target area containing at least part of the target object, it is specifically configured to: determine a feature point on the target object in the first preview image; determine a circular area with the feature point as the center as the target area, and the radius of the circular area being a preset value.

In some embodiments, when the control unit 1104 marks the target object in the first preview image and obtains a target area containing at least part of the target object, it is specifically configured to: determine the contour line of the target object in the first preview image; and determine the area surrounded by the contour line as the target area.

In some embodiments, when the control unit 1104 controls the camera to shoot to obtain the target image based on the second preview image, it is specifically configured to: determine a first contrast of the target area in the second preview image; if the first contrast is greater than or equal to a preset threshold, control the camera to shoot to obtain the target image based on the second preview image.

In some embodiments, when the control unit 1104 controls the camera to shoot to obtain the target image according to the second preview image, it is specifically configured to:

If the first contrast is less than a preset threshold, control the camera to refocus so that the shooting focus of the camera is in the target area, and obtain a new second preview image; and perform the step of determining a first contrast of the target area in the second preview image.

In some embodiments, the indication information includes: natural language information in text format and/or natural language information in voice format.

In some embodiments, the indication information further includes at least one of: context information of the natural language information, the user's gaze point, the user's gaze direction, and the user's gesture.

In some embodiments, it also includes: a processing unit (not shown), configured to input the target image and the indication information into a pre-trained question-answering model for processing to obtain reply information of the indication information.

The device or apparatus provided in this embodiment can be used to execute the technical solution of the above method embodiment. Its implementation principle and technical effect are similar, and this embodiment will not be repeated here.

In order to implement the above embodiment, the embodiment of the present disclosure further provides a wearable device, including the above image processing apparatus and a camera.

Among them, the wearable device includes: a ring, a necklace, headphones or glasses, etc.

In order to implement the above embodiments, the embodiments of the present disclosure further provide a computer-readable storage medium, in which computer-executable instructions are stored. When a processor executes the computer-executable instructions, an image processing method as described in any of the above embodiments is implemented.

In order to implement the above embodiments, the embodiments of the present disclosure further provide a computer program product, including a computer program, which implements the image processing method of any of the above embodiments when executed by a processor.

In order to implement the above embodiment, the present disclosure also provides an electronic device, including: a processor and a memory;
the memory stores computer-executable instructions;
the processor executes the computer-executable instructions stored in the memory, so that the processor executes the image processing method as described in any of the above embodiments.

FIG. 12 is a schematic diagram of the structure of an electronic device provided in an embodiment of the present disclosure, and the electronic device 1200 may be a terminal device or a server. The terminal device may include but is not limited to mobile terminals such as mobile phones, laptop computers, digital broadcast receivers, personal digital assistants (PDAs), tablet computers (Portable Android Devices, PADs), portable multimedia players (Portable Media Players, PMPs), vehicle-mounted terminals (such as vehicle-mounted navigation terminals), etc., and fixed terminals such as digital TVs, desktop computers, etc. The electronic device shown in FIG. 12 is only an example and should not bring any limitation to the functions and scope of use of the embodiments of the present disclosure.

As shown in FIG. 12, an electronic device 1200 may include a processing apparatus (such as a central processing unit, a graphics processor, etc.) 1201, which may perform various appropriate actions and processes according to a program stored in a Read Only Memory (ROM)1202 or a program loaded from a storage apparatus 1208 into a Random Access Memory (RAM)1203. In the RAM 1203, various programs and data required for the operation of the electronic device 1200 are also stored. A processing apparatus 1201, a ROM 1202 and a RAM 1203 are connected to each other through a bus 1204. An input/output (I/O) interface 1205 is also connected to the bus 1204.

Typically, the following devices may be connected to the I/O interface 1205: an input apparatus 1206 including, for example, a touch screen, a touchpad, a keyboard, a mouse, a camera, a microphone, an accelerometer, a gyroscope, etc.; an output apparatus 1207 including, for example, a liquid crystal display (LCD), a speaker, a vibrator, etc.; storage apparatus 1208 including, for example, a magnetic tape, a hard disk, etc.; and a communication apparatus 1209. The communication apparatus 1209 may allow the electronic device 1200 to communicate with other devices wirelessly or by wire to exchange data. Although FIG. 12 shows an electronic device 1200 having various apparatus, it should be understood that it is not required to implement or have all the devices shown. More or fewer apparatus may be implemented or provided alternatively.

In particular, according to an embodiment of the present disclosure, the process described above with reference to the flowchart can be implemented as a computer software program. For example, an embodiment of the present disclosure includes a computer program product, which includes a computer program carried on a computer-readable medium, and the computer program contains program code for executing the method shown in the flowchart. In such an embodiment, the computer program can be downloaded and installed from a network through a communication apparatus 1209, or installed from a storage apparatus 1208, or installed from a ROM 1202. When the computer program is executed by the processing apparatus 1201, the above-mentioned functions defined in the method of the embodiment of the present disclosure are executed.

It should be noted that the computer-readable medium mentioned above in the present disclosure may be a computer-readable signal medium or a computer-readable storage medium or any combination of the above two. The computer-readable storage medium may be, for example, but not limited to, an electrical, magnetic, optical, electromagnetic, infrared, or semiconductor system, device or device, or any combination of the above. More specific examples of computer-readable storage media may include, but are not limited to: an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, a computer-readable storage medium may be any tangible medium containing or storing a program that can be used by or in combination with an instruction execution system, device or device. In the present disclosure, a computer-readable signal medium may include a data signal propagated in a baseband or as part of a carrier wave, which carries a computer-readable program code. This propagated data signal may take a variety of forms, including but not limited to an electromagnetic signal, an optical signal, or any suitable combination of the above. Computer readable signal media may also be any computer readable medium other than computer readable storage media, which may send, propagate or transmit a program for use by or in conjunction with an instruction execution system, apparatus or device. The program code contained on the computer readable medium may be transmitted using any appropriate medium, including but not limited to: wires, optical cables, RF (radio frequency), etc., or any suitable combination of the above.

The computer-readable medium may be included in the electronic device, or may exist independently without being installed in the electronic device.

The computer-readable medium carries one or more programs. When the one or more programs are executed by the electronic device, the electronic device executes the method shown in the above embodiment.

Computer program code for performing the operations of the present disclosure may be written in one or more programming languages or a combination thereof, including object-oriented programming languages such as Java, Smalltalk, C++, and conventional procedural programming languages such as “C” or similar programming languages. The program code may be executed entirely on the target user computer, partially on the target user computer, as a separate software package, partially on the target user computer and partially on a remote computer, or entirely on a remote computer or server. In the case of a remote computer, the remote computer may be connected to the target user computer via any type of network, including a local area network (LAN) or a wide area network (WAN), or may be connected to an external computer (e.g., via the Internet using an Internet service provider).

The flow chart and block diagram in the accompanying drawings illustrate the possible architecture, function and operation of the system, method and computer program product according to various embodiments of the present disclosure. In this regard, each square box in the flow chart or block diagram can represent a module, a program segment or a part of a code, and the module, the program segment or a part of the code contains one or more executable instructions for realizing the specified logical function. It should also be noted that in some implementations as replacements, the functions marked in the square box can also occur in a sequence different from that marked in the accompanying drawings. For example, two square boxes represented in succession can actually be executed substantially in parallel, and they can sometimes be executed in the opposite order, depending on the functions involved. It should also be noted that each square box in the block diagram and/or flow chart, and the combination of the square boxes in the block diagram and/or flow chart can be implemented with a dedicated hardware-based system that performs a specified function or operation, or can be implemented with a combination of dedicated hardware and computer instructions.

The units involved in the embodiments described in the present disclosure may be implemented by software or hardware. The name of a unit does not limit the unit itself in some cases. For example, the first acquisition unit may also be described as a “unit for acquiring at least two Internet Protocol addresses”.

The functions described above herein may be performed at least in part by one or more hardware logic components. For example, without limitation, exemplary types of hardware logic components that may be used include: field programmable gate arrays (FPGAs), application specific integrated circuits (ASICs), application specific standard products (ASSPs), systems on chips (SOCs), complex programmable logic devices (CPLDs), and the like.

In the context of the present disclosure, a machine-readable medium may be a tangible medium that may contain or store a program for use by or in conjunction with an instruction execution system, device, or equipment. A machine-readable medium may be a machine-readable signal medium or a machine-readable storage medium. A machine-readable medium may include, but is not limited to, an electronic, magnetic, optical, electromagnetic, infrared, or semiconductor system, device, or device, or any suitable combination of the foregoing. A more specific example of a machine-readable storage medium may include an electrical connection based on one or more lines, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the foregoing.

In a first aspect, according to one or more embodiments of the present disclosure, there is provided an image processing method, comprising: obtaining a first preview image captured by a camera; obtaining indication information for the first preview image; inputting the indication information and the first preview image into a pre-trained multimodal recognition model for recognition to obtain a target object in the first preview image; and controlling the camera to capture the target image with the target object as the shooting focus of the camera.

According to one or more embodiments of the present disclosure, controlling the camera to capture the target image with the target object as the shooting focus of the camera comprises: marking the target object in a first preview image to obtain a target area containing at least a portion of the target object; controlling the camera to focus so that the shooting focus of the camera is in the target area to obtain a second preview image; and controlling the camera to shoot to obtain the target image based on the second preview image.

According to one or more embodiments of the present disclosure, marking a target object in a first preview image to obtain a target area containing at least a portion of the target object comprises: in the first preview image, determining a rectangular area surrounding the target object as the target area.

According to one or more embodiments of the present disclosure, marking a target object in a first preview image to obtain a target area containing at least a portion of the target object comprises: determining a feature point on the target object in the first preview image; determining a circular area with the feature point as the center as the target area, and the radius of the circular area being a preset value.

According to one or more embodiments of the present disclosure, marking a target object in a first preview image to obtain a target area containing at least part of the target object, comprises: determining a contour line of the target object in the first preview image; and determining an area surrounded by the contour line as the target area.

According to one or more embodiments of the present disclosure, according to the second preview image, controlling the camera to shoot to obtain the target image comprises: determining a first contrast of the target area in the second preview image; if the first contrast is greater than or equal to a preset threshold, controlling the camera to shoot to obtain the target image based on the second preview image.

According to one or more embodiments of the present disclosure, based on the second preview image, controlling the camera to shoot to obtain the target image also comprises: if the first contrast is less than a preset threshold, controlling the camera to refocus so that the shooting focus of the camera is in the target area to obtain a new second preview image; and executing the step of determining the first contrast of the target area in the second preview image.

According to one or more embodiments of the present disclosure, the indication information includes: natural language information in text format and/or natural language information in voice format.

According to one or more embodiments of the present disclosure, the indication information further includes at least one of: context information of the natural language information, the user's gaze point, the user's gaze direction, and the user's gesture.

According to one or more embodiments of the present disclosure, the present invention further comprises:
inputting the target image and indication information into the pre-trained question-answering model for processing to obtain the reply information of the indication information.

In a second aspect, according to one or more embodiments of the present disclosure, there is provided an image processing apparatus, comprising:
a first obtaining unit, configured to obtain a first preview image captured by a camera;
a second obtaining unit, configured to obtain indication information for the first preview image;
a recognition unit, configured to input the indication information and the first preview image into a pre-trained multimodal recognition model for recognition, to obtain a target object in the first preview image; and
a control unit, configured to control the camera to take the target object as the shooting focus of the camera to shoot the target image.

In a third aspect, according to one or more embodiments of the present disclosure, there is provided a wearable device, comprising: the image processing apparatus and a camera of the second aspect.

In a fourth aspect, according to one or more embodiments of the present disclosure, there is provided an electronic device, comprising: at least one processor and a memory;
memory stores computer-executable instructions;
at least one processor executes the computer-executable instructions stored in the memory, so that the at least one processor executes the image processing method as described in the first aspect and various possible designs of the first aspect.

In a fifth aspect, according to one or more embodiments of the present disclosure, a computer-readable storage medium is provided, in which computer execution instructions are stored. When a processor executes the computer execution instructions, the image processing method as described in the first aspect and various possible designs of the first aspect are implemented.

In a sixth aspect, according to one or more embodiments of the present disclosure, a computer program product is provided, including a computer program, which, when executed by a processor, implements the image processing method of the first aspect and various possible designs of the first aspect.

The above description is only a preferred embodiment of the present disclosure and an explanation of the technical principles used. Those skilled in the art should understand that the scope of disclosure involved in the present disclosure is not limited to the technical solutions formed by a specific combination of the above technical features, but should also cover other technical solutions formed by any combination of the above technical features or their equivalent features without departing from the above disclosed concept. For example, the above features are replaced with the technical features with similar functions disclosed in the present disclosure (but not limited to) by each other to form a technical solution.

In addition, although each operation is described in a specific order, this should not be understood as requiring these operations to be performed in the specific order shown or in a sequential order. Under certain circumstances, multitasking and parallel processing may be advantageous. Similarly, although some specific implementation details are included in the above discussion, these should not be interpreted as limiting the scope of the present disclosure. Some features described in the context of a separate embodiment can also be implemented in a single embodiment in combination. On the contrary, the various features described in the context of a single embodiment can also be implemented in multiple embodiments individually or in any suitable sub-combination mode.

Although the subject matter has been described in language specific to structural features and/or methodological logical actions, it should be understood that the subject matter defined in the appended claims is not necessarily limited to the specific features or actions described above. On the contrary, the specific features and actions described above are merely example forms of implementing the claims.

I/We claim:

1. An image processing method, comprising:
obtaining a first preview image captured by a camera;
obtaining indication information for the first preview image;
obtaining a target object in the first preview image by inputting the indication information and the first preview image into a pre-trained multimodal recognition model for recognition; and
shooting a target image by controlling the camera to take the target object as a shooting focus of the camera.

2. The image processing method according to claim 1, wherein shooting the target image by controlling the camera to take the target object as the shooting focus of the camera comprises:
obtaining a target area containing at least a portion of the target object by marking the target object in the first preview image;
obtaining a second preview image by controlling the camera to focus so that the shooting focus of the camera is in the target area; and
obtaining the target image by controlling the camera to shoot based on the second preview image.

3. The method according to claim 2, wherein obtaining the target area containing at least a portion of the target object by marking the target object in the first preview image comprises:
determining a rectangular area surrounding the target object as the target area in the first preview image.

4. The method according to claim 2, wherein obtaining the target area containing at least a portion of the target object by marking the target object in the first preview image comprises:
determining a feature point on the target object in the first preview image; and
determining a circular area with the feature point as a center as the target area, a radius of the circular area being a preset value.

5. The method according to claim 2, wherein obtaining the target area containing at least a portion of the target object by marking the target object in the first preview image comprises:
determining a contour line of the target object in the first preview image; and
determining an area surrounded by the contour line as the target area.

6. The method according to claim 2, wherein obtaining the target image by controlling the camera to shoot based on the second preview image comprises:
determining a first contrast of the target area in the second preview image; and
in response to the first contrast being greater than or equal to a preset threshold, obtaining the target image by controlling the camera to shoot based on the second preview image.

7. The method according to claim 6, wherein obtaining the target image by controlling the camera to shoot based on the second preview image further comprises:
in response to the first contrast being less than the preset threshold, obtaining a new second preview image by controlling the camera to refocus so that the shooting focus of the camera is in the target area; and
performing a step of determining the first contrast of the target area in the second preview image.

8. The method according to claim 1, wherein the indication information comprises: natural language information in text format and/or the natural language information in voice format.

9. The method according to claim 8, wherein the indication information further comprises at least one of: context information of the natural language information, a gaze point of a user, a gaze direction of the user, and a user gesture.

10. The method according to claim 1, further comprising:
obtaining reply information of the indication information by inputting the target image and the indication information into a pre-trained question-answering model for processing.

11. An electronic device, comprising: a processor and a memory;
the memory stores computer-executable instructions;
the computer-executable instructions, when executed by the processor, cause the processor to:
obtain a first preview image captured by a camera;
obtain indication information for the first preview image;
obtain a target object in the first preview image by inputting the indication information and the first preview image into a pre-trained multimodal recognition model for recognition; and
shoot a target image by controlling the camera to take the target object as a shooting focus of the camera.

12. The electronic device according to claim 11, wherein the computer-executable instructions causing the processor to shoot the target image by controlling the camera to take the target object as the shooting focus of the camera comprise instructions to:
obtain a target area containing at least a portion of the target object by marking the target object in the first preview image;
obtain a second preview image by controlling the camera to focus so that the shooting focus of the camera is in the target area; and
obtain the target image by controlling the camera to shoot based on the second preview image.

13. The electronic device according to claim 12, wherein the computer-executable instructions causing the processor to obtain the target area containing at least a portion of the target object by marking the target object in the first preview image comprise instructions to:
determine a rectangular area surrounding the target object as the target area in the first preview image.

14. The electronic device according to claim 12, wherein the computer-executable instructions causing the processor to obtain the target area containing at least a portion of the target object by marking the target object in the first preview image comprise instructions to:
determine a feature point on the target object in the first preview image; and
determine a circular area with the feature point as a center as the target area, a radius of the circular area being a preset value.

15. The electronic device according to claim 12, wherein the computer-executable instructions causing the processor to obtain the target area containing at least a portion of the target object by marking the target object in the first preview image comprise instructions to:
determine a contour line of the target object in the first preview image; and
determine an area surrounded by the contour line as the target area.

16. The electronic device according to claim 12, wherein the computer-executable instructions causing the processor to obtain the target image by controlling the camera to shoot based on the second preview image comprise instructions to:
determine a first contrast of the target area in the second preview image; and
in response to the first contrast being greater than or equal to a preset threshold, obtain the target image by controlling the camera to shoot based on the second preview image.

17. The electronic device according to claim 16, wherein the computer-executable instructions causing the processor to obtain the target image by controlling the camera to shoot based on the second preview image further comprise instructions to:
in response to the first contrast being less than the preset threshold, obtain a new second preview image by controlling the camera to refocus so that the shooting focus of the camera is in the target area; and
perform a step of determining the first contrast of the target area in the second preview image.

18. The electronic device according to claim 11, wherein the indication information comprises:
natural language information in text format and/or the natural language information in voice format.

19. The electronic device according to claim 18, wherein the indication information further comprises at least one of: context information of the natural language information, a gaze point of a user, a gaze direction of the user, and a user gesture.

20. A non-transitory computer-readable storage medium, wherein the computer-readable storage medium stores computer-executable instructions, and the computer-executable instructions, when executed by a processor, cause the processor to:
obtain a first preview image captured by a camera;
obtain indication information for the first preview image;
obtain a target object in the first preview image by inputting the indication information and the first preview image into a pre-trained multimodal recognition model for recognition; and
shoot a target image by controlling the camera to take the target object as a shooting focus of the camera.
